(19) United States
(12) Patent Application Publication
(10) Pub. No.: US 2013/0167123 A1
(43) Pub. Date: Jun. 27, 2013

(54) APPLICATION DEBUGGING

(71) Applicants: Daniel Dura, Garland, TX (US); Christian Cantrell, Sterling, VA (US)

(72) Inventors: Daniel Dura, Garland, TX (US); Christian Cantrell, Sterling, VA (US)

(73) Assignee: Adobe Systems Incorporated

(21) Appl. No.: 12/338,837

(22) Filed: Dec. 18, 2008

(51) Int. Cl. G06F 9/44; G06F 9/45

(52) U.S. Cl. 717/127; 717/140

(57) ABSTRACT

A computer implemented method including receiving an input, translating the input into a compiled application having a client portion and a server portion, receiving a client portion testing location and a server portion testing location, and instantiating a client virtual machine and a server virtual machine according to the respective client portion testing location and the server portion testing location. The method includes executing the compiled client application portion on the client virtual machine instantiated, executing the compiled server application portion on the server virtual machine instantiated, and monitoring execution of the compiled client and server application portions on the respective client and server virtual machines.

### BACKGROUND

This disclosure relates to debugging distributed software applications. A software developer typically uses an integrated development environment (IDE), also known as integrated design environment or integrated debugging environment, for developing software applications. An IDE generally provides comprehensive facilities for software development and normally includes a source code editor, a compiler and/or interpreter, build automation tools, and a debugger. Sometimes a version control system and various other development tools are integrated into the IDE to simplify the construction of a graphical user interface (GUI). Some IDEs also have a class browser, an object inspector, and a class hierarchy diagram, for use with object oriented software development.

Software applications, such as rich internet applications (RIAs), which are web applications that generally have the features and functionality of traditional desktop applications, may include client and server portions for execution on a respective client computing device and a server computing device. RIAs typically form a stateful client application with a separate services layer on the backend. RIAs typically run in a web browser, or do not require software installation on a local machine, and run locally in a secure environment called a sandbox. A sandbox is generally a security mechanism for safely running programs. Sandboxes are often used to execute untested code, or non-trusted programs from unverified third-parties, suppliers and non-trusted users. An IDE may be used to develop an RIA and to manage the client and server portions of the application. Debugging software applications, such as RIAs, that have client and server portions currently entails individually debugging and maintaining the separate client and server software application portions.

### SUMMARY

In general, in one aspect, a computer implemented method for debugging a distributed application includes receiving programming language input, translating the programming language input into a compiled application having a client portion and a server portion, and receiving a client portion testing location and a distinct server portion testing location. The method includes instantiating a client virtual machine according to the client portion testing location, instantiating a server virtual machine according to the server portion testing location, executing the compiled client application portion on the instantiated client virtual machine, and executing the compiled server application portion on the instantiated server virtual machine. The method further includes monitoring execution of the compiled client and server application portions on the respective client and server virtual machines. The monitoring execution includes communicating with the client and server virtual machines for debugging the compiled application of the programming language input.

These and other implementations can optionally include one or more of the following features. In some implementations, monitoring execution further includes at least one of: providing a input source code location related to a failure of the compiled application, executing the compiled application step-by-step of the programming language input, stopping execution of the compiled application for providing a variable state, and modifying a state of the executed compiled application. Communicating with the client and server virtual machines may include at least one of: communicating over a network and communicating within shared memory. In some examples, the client portion testing location includes at least one of a local computing device and a client computing device. The server portion testing location may include at least one of a local computing device and a cloud computing service.

The method may further include applying a criteria to the input for translating the input into the compiled client and server application portions. In some examples, applying the criteria includes translating portions of the input into the compiled client application portion that include at least one of: having an execution time on a client computing device less than a threshold client execution time, relating to a graphical user interface, metadata indicating inclusion in the compiled client application portion, source code class usage indicating inclusion in the compiled client application portion, and a combination thereof. Applying the criteria may include translating portions of the input into the compiled server application portion that include at least one of: having an execution time on a client computing device greater than a threshold client execution time, invoking services running on a server computing device, invoking an application programming interface running on a server computing device, metadata indicating inclusion in the compiled server application portion, source code class usage indicating inclusion in the compiled server application portion, and a combination thereof.

The method may further include selecting a run-time environment and translating the input into the compiled client and server application portions based on the run-time environment. In some examples, the method includes producing communication module for communication between the compiled client and server application portions.

In general, another aspect of the subject matter described in this specification can be embodied in a computer program product, encoded on a computer-readable medium, operable to cause data processing apparatus to perform operations that include receiving programming language input, translating the programming language input into a compiled application having a client portion and a server portion, and receiving a client portion testing location a server portion testing location. Operations include instantiating a client virtual machine according to the client portion testing location, instantiating a server virtual machine according to the server portion testing location, executing the compiled client application portion on the client virtual machine instantiated, and executing the compiled server application portion on the server virtual machine instantiated. Operations include monitoring execution of the compiled client and server application portions on the respective client and server virtual machines. The monitoring execution includes communicating with the client and server virtual machines for debugging the compiled application of the programming language input.

These and other implementations can optionally include one or more of the following features. In some implementations, monitoring execution includes at least one of: providing a input source code location related to a failure of the compiled application, executing the compiled application step-by-step of the programming language input, stopping execution of the compiled application for providing a variable state, and modifying a state of the executed compiled application. Communicating with the client and server virtual machines may include at least one of: communicating over a network and communicating within shared memory. In some examples, the client portion testing location comprises at least one of a local computing device and a client computing device. The server portion testing location may include at least one of a local computing device and a cloud computing service.

The operations performed by the data processing apparatus may include applying a criteria to the input for translating the input into the compiled client and server application portions. In some implementations, applying the criteria includes translating portions of the input into the compiled client application portion that include at least one of: having an execution time on a client computing device less than a threshold client execution time, relating to a graphical user interface, metadata indicating inclusion in the compiled client application portion, source code class usage indicating inclusion in the compiled client application portion, and a combination thereof. Applying the criteria may include translating portions of the input into the compiled server application portion that include at least one of: having an execution time on a client computing device greater than a threshold client execution time, invoking services running on a server computing device, invoking an application programming interface running on a server computing device, metadata indicating inclusion in the compiled server application portion, source code class usage indicating inclusion in the compiled server application portion, and a combination thereof.

The operations performed by the data processing apparatus may further include selecting a run-time environment and translating the input into the compiled client and server application portions based on the run-time environment. Operations may also include producing communication module for communication between the compiled client and server application portions.

In general, another aspect of the subject matter described in this specification can be embodied in a system comprising a computing device that includes a computer-readable medium including instructions and one or more processors configured to execute the instructions and perform operations that include a compiler and a debugger. The compiler is configured for receiving an input, translating the input into a compiled application having a client portion and a server portion. The debugger is configured for executing the compiled client application portion on a client virtual machine instantiated according to a client portion testing location, executing the compiled server application portion on a server virtual machine instantiated according to a server portion testing location, and monitoring execution of the compiled client and server application portions on the respective client and server virtual machines. The monitoring execution includes communicating with the client and server virtual machines for debugging the compiled application of the programming language input.

These and other implementations can optionally include one or more of the following features. In some implementations, monitoring execution further includes at least one of: providing a input source code location related to a failure of the compiled application, executing the compiled application step-by-step of the programming language input, stopping execution of the compiled application for providing a variable state, and modifying a state of the executed compiled application. Communicating with the client and server virtual machines may include at least one of: communicating over a network and communicating within shared memory. In some examples, the client portion testing location comprises at least one of a local computing device and a client computing device. The server portion testing location may include at least one of a local computing device and a cloud computing service.

In some implementations, the compiler is configured for applying a criteria to the input for translating the input into the compiled client and server application portions. Applying the criteria may include translating portions of the input into the compiled client application portion that include at least one of: having an execution time on a client computing device less than a threshold client execution time, relating to a graphical user interface, metadata indicating inclusion in the compiled client application portion, source code class usage indicating inclusion in the compiled client application portion, and a combination thereof. Applying the criteria may include translating portions of the input into the compiled server application portion that include at least one of: having an execution time on a client computing device greater than a threshold client execution time, invoking services running on a server computing device, invoking an application programming interface running on a server computing device, metadata indicating inclusion in the compiled server application portion, source code class usage indicating inclusion in the compiled server application portion, and a combination thereof.

In some implementations, the compiler is configured for selecting a run-time environment and translating the input into the compiled client and server application portions based on the run-time environment. The compiler may be configured for producing communication module for communication between the compiled client and server application portions. In some implementations, the system further includes a local computing device and a cloud computing service. The local computing device executes an integrated development environment having an editor, the compiler, and the debugger. The cloud computing service includes a server computing device having a service abstraction layer and a hypertext transfer protocol wrapper over the server virtual machine instantiated thereon. The server computing device is configured to parse HTTP requests and send HTTP responses.

Particular embodiments of the subject matter described in this specification can be implemented to realize one or more of the following advantages. The present disclosure provides a technique for developing an application under a single framework (e.g., single code base), such that a compiler and/or virtual machine produces the client and server portions of the application, thereby allowing a user (e.g., software developer) to develop the application as a single application (e.g., within an IDE) without managing separate client and server applications and the communications there between. Other advantages include freeing the software developer from having to worry about client capabilities since different versions of the client code can be compiled for devices with different specifications and capabilities.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example computer for software development.

FIG. 2 is a schematic view of an example compiler for compiling applications.

FIG. 3 is a schematic view of example interactions among a cloud computing service, a client computing device, a deployer, a compiler, and an integrated development environment.

FIG. 4 is a flowchart that represents example operations of a compiler.

FIG. 5 is a flowchart that represents example operations of a deployer.

FIGS. 6 and 7 are schematic views of example interactions among a cloud computing service, a client computing device, a deployer, a compiler, and an integrated development environment (IDE) for deploying a compiled application.

FIG. 8 is a schematic view of an example debugger and an example compiler.

FIG. 9 is a schematic view of an example debugger testing portions of a compiled application on virtual machines instantiated by an integrated development environment (IDE).

FIG. 10 is a schematic view of a debugger testing portions of a compiled application on a local virtual machine instantiated by an integrated development environment (IDE) and on server virtual machine instantiated by a cloud computing service.

FIG. 11 is a schematic view of a debugger testing portions of a compiled application on virtual machines instantiated by a cloud computing service and a client computing device.

FIG. 12 is a flowchart that represents exemplary operations of a debugger.

Like reference symbols in the various drawings indicate like elements.

### DETAILED DESCRIPTION

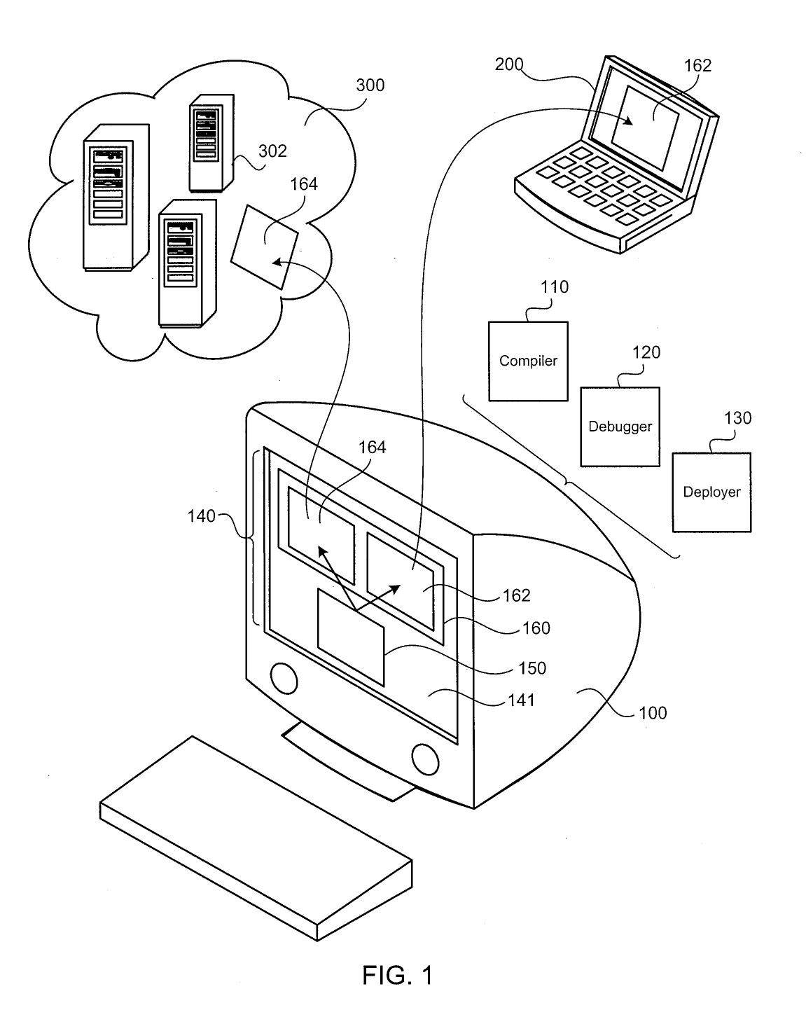

FIG. 1 illustrates, in general, a software development paradigm or technique that allows a user (e.g., software developer) to write and maintain a single code base for an application 150 in an integrated development environment (IDE) 140, executable on a computer 100, for deployment to a cloud computing service 300 and optionally a client computing device 200. In various implementations, the application 150 is translated into a compiled application 160 and separated into a compiled client application portion 162 and a compiled server application portion 164 without requiring intervention by the user. FIG. 1 shows a schematic representation of the application 150, in a graphical user interface (GUI) 141 of the IDE 140, being translated into a compiled application 160 and separated into a compiled client application portion 162 and a compiled server application portion 164. As a result, a user is not required to write and maintain separate client and server code portions of the application 150 and the communications therebetween (e.g., asynchronous calling). In some implementations, the application 150 is written in one or more programming languages (e.g., Action Script, C++, Java, ECMAScript, or MXML), using a single framework. A software framework is an abstraction in which common code providing generic functionality can be selectively overridden or specialized by user code providing specific functionality. Frameworks are similar to software libraries in that they are reuseable abstractions of code wrapped in a well-defined application programming interface (API). Unlike libraries, however, the overall program's flow of control is not dictated by the caller, but by the framework. This inversion of control is the distinguishing feature of software frameworks.

The software development paradigm includes a compiling stage, a debugging stage, and a deploying stage. In the compiling stage, a compiler 110 (e.g., a programming language implementer, such as a compiler or interpreter), executable on the computer 100 or another computer, compiles or translate the application 150 into a compiled application 160, which may be segmented or parsed into the compiled client and server application portions 162, 164. In the debugging stage, the user uses a debugger 120, executable on the computer 100 or another computer (e.g., a computing device 302 in a cloud computer service 300), for debugging the code (e.g., to find and correct errors) so that the compiled application 160 runs or functions substantially without errors. In the deploying stage, the user utilizes a deployer 130, executable on the computer 100 or another computer, for deploying the compiled application 150 to a deployment space. For example, the client application portion 162 may be deployed to the client device 200 (e.g., portable computing device) and the compiled server application portion 164 may be deployed to the cloud computing service 300 where the compiled server application portion 164 executes on a server computing device 302, for example. The IDE 140 receives a deployment request from a user, and in response to the deployment request, executes deployment of the compiled application 160 via the deployer 130. The user may click a button (e.g., as a single user event) in the graphical user interface 141 of the IDE 140 to send the deployment request. The IDE 140 recognizes receipt of the deployment request and calls the deployer 130 to carry out deployment of the compiled application 160.

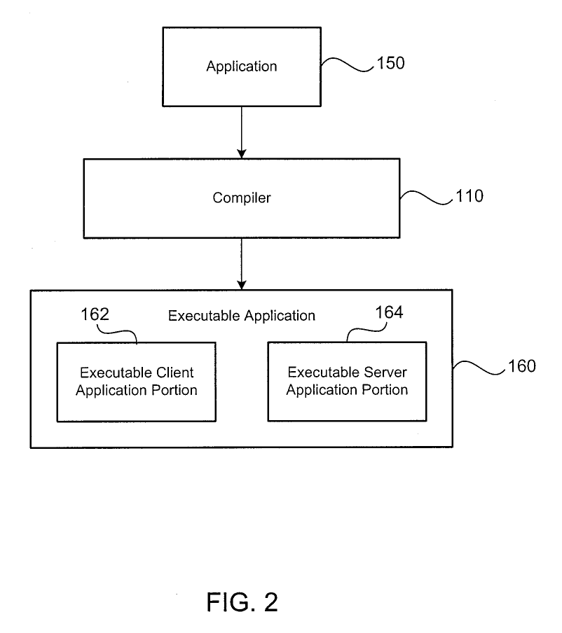

Referring to FIG. 2, in some implementations, the compiler 110 is configured to receive input (e.g., the application 150 from the IDE 140) and compile or translate the input into a compiled application 160. The compiler 110 may be a computer program (or set of programs) that translates text or symbols written in a computer programming language into another a target language, for example, to create a compiled application or program 160. The application 150 comprises source code (e.g., a high-level programming language), which is translated into executable code (e.g., object code, intermediate code, or a lower level language, such as assembly language or machine language) of the compiled application 160. Generally, the executable code has a form suitable for processing by other programs (e.g., a linker) or a virtual machine, but may be a human-readable text file.

In some implementations, the compiler 110 translates the application 150 into a compiled application 160 having a compiled client application portion 162 and a compiled server application portion 164. The compiler 110 may apply a criteria to the application 150 for producing the compiled client application portion 162 and the compiled server application portion 164. In some examples, the criteria includes selecting portions of the application 150 that have an execution time on a client computing device 200 less than a threshold client execution time and/or relate to a graphical user interface (GUI) functionality, and translating those portions into the compiled client application portion 162. In some examples, the criteria includes selecting portions of the application 150 having an execution time on the client computing device 200 greater than a threshold (e.g., a threshold client execution time), invoke services executable on a server computing device 302, and/or invoke application programming interfaces (API) executable on the server computing device 302, and translating those portions into the compiled server application portion 164.

In some implementations, the compiler 110 divides the compiled application 160 into the compiled client application portion 162 and the compiled server application portion 164 based on metadata in the application 150 (e.g., in the source code of the application 150). The user can specify a communication protocol (e.g., Action Message Format (AMF), Simple Object Access Protocol (SOAP), JavaScript Object Notation (JSON), etc.) for communications between the compiled client and server application portions 162, 164. The user may stipulate in the metadata a type of encryption and/or authentication between the compiled client and server application portions 162, 164.

During development of the application 150, the user may select specific local and remote classes of code designated for respective use in the compiled client application portion 162 and the compiled server application portion 164. During compilation of the application 150, the compiler 110 recognizes the local and remote classes and translates the source code into the respective compiled application portions 162, 164. In some examples, the compiler 110 divides the compiled application 160 into the compiled client application portion 162 and the compiled server application portion 164 based on a run-time environment (e.g., a local computing device or a remote computing device) selected by the user for the compiled application 160. The compiler 110 may be configured to provide a communication module for communication (e.g., asynchronous communication) between the compiled client application portion 162 and the compiled server application portion 164.

In some implementations, the compiler 110 translates the application 150 into a compiled application 160, which is divided or segmented into the compiled client application portion 162 and the compiled server application portion 164 at run-time, for example, by a virtual machine (VM), a native code client computing device, and/or a native code server computing device. In some examples, the user attributes metadata (e.g., a “dynamic” metadata type) to the source code of the application 150 indicating that the compiled client and server application portions 162, 164 will be produced at run-time from the compiled application 160. The same criteria for apportioning the client and server application portions 162, 164 described with respect to the compiler 110 may be used by the virtual machine.

In some implementations, the compiler 110 is configured to perform one or more of the following operations: lexical analysis, preprocessing, parsing, semantic analysis, code generation, and code optimization. The output produced by the compiler 110 may be executable on a virtual machine that may or may not reside on the same platform as the compiler 110.

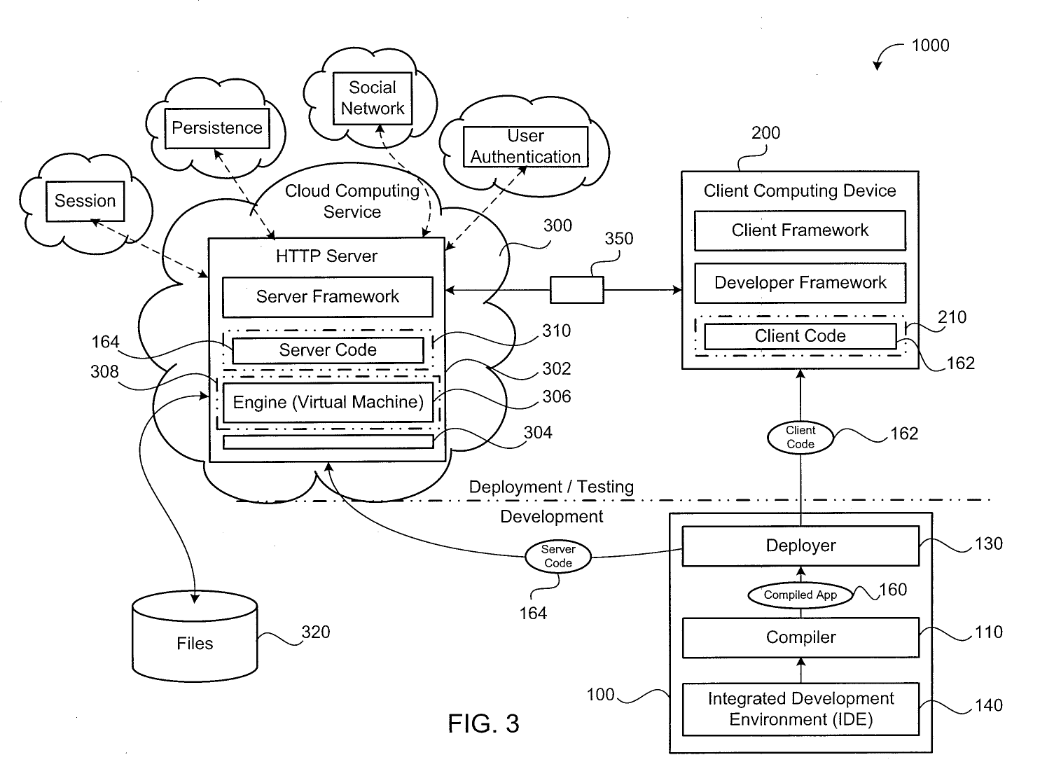

Referring to FIG. 3, in some implementations, a system 1000 includes at least one of the local computing device 100 (e.g., a computer), the client computing device 200, and the cloud computing service 300. In the exemplary system 1000 shown, the local computing device 100 executes the IDE 140, and may also execute the compiler 110 and the deployer 130. In some examples the IDE 140 includes the compiler 110, the debugger 120, and the deployer 130. The cloud computing service 300 includes at least one server computing device 302 which may include a service abstraction layer 304 and a hypertext transfer protocol wrapper 308 over the server virtual machine 306 instantiated thereon. The server computing device 302 may be configured to parse HTTP requests and send HTTP responses. The deployer 130 is configured to receive the compiled application 160 (e.g., from the compiler 110, which may be part of the IDE 140) for deployment to a deployment space 210, 310 (e.g., according to a user preference).

In the example illustrated in FIG. 3, the compiler 110 is configured to produce the compiled client and server application portions 162, 164 for deployment to a respective client deployment space 210 and a server deployment space 310. Each deployment space 210, 310 is associated with a name and a permissions requirement. The server deployment space 310 is in a cloud computing service 300 having a plurality of computing devices 302 and a service abstraction layer 304. In some implementations, the deployer 130 is configured to verify user credentials before deploying the compiled application 160. Deploying the compiled application 160 may include associating the compiled client and server application portions 162, 164 with the respective deployment spaces 210, 310, and installing the compiled client and server application portions 162, 164 to a corresponding client computing device 200 and a server computing device 302 in the cloud computing service 300. In some examples, the server computing device 302 is selected from the plurality of server computing devices 302 in the cloud computing service 300 by evaluating a computing load for each server computing device 302. The cloud computing service 300 may assign a permanent unique URL to the server deployment space 310, which may be mapped to a user-selected domain name. Also, the cloud computing service 300 may process a permissions requirement of the server deployment space 310, and manage access to the compiled server application portion 164 according to the permissions requirement of the server deployment space 310. In some examples, the cloud computing service 300 manages access to the compiled server application portion 164 by requiring at least one of a user name and password to access the permanent unique URL. A virtual machine 306 on the server computing device 302 is configured to execute the compiled server application portion 164 and communicate with the client computing device 200 for execution of the compiled client application portion 162.

In some examples, the cloud computing service 300 is configured to communicate with a repository 320 (e.g., database, file server, etc.) for storing and accessing at least one of the compiled application 160 and the compiled client and server application portions 162, 164. In the example shown in FIG. 3, the server computing device 302 (e.g., HTTP server) communicates with the repository 320 for accessing and executing the compiled client and server application portions 162, 164.

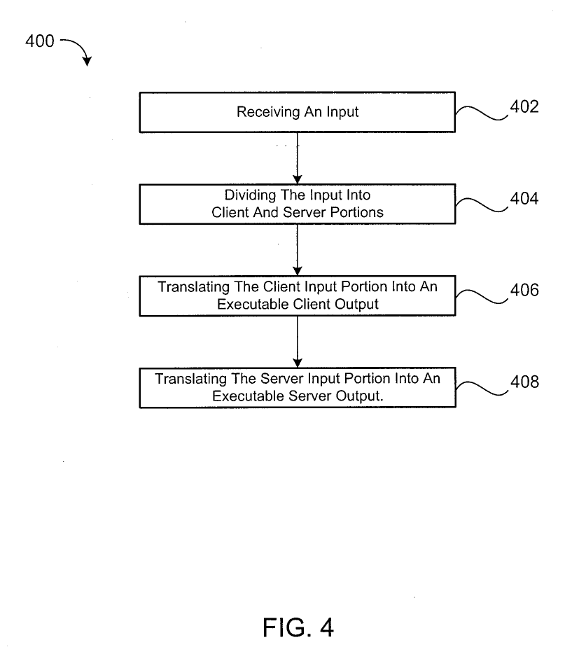

Referring to FIG. 4, a flowchart 400 represents an arrangement of compiling operations of the compiler 110. Typically, the compiling operations are executed on a processor present in the computer 100, upon which the compiler 110 resides; however, the compiling operations may also be executed by multiple processors present in the computer 100. While typically executed by a single computer 100 (e.g., electronic device or computing device), in some arrangements, operation execution may be distributed among two or more computers 100. Compiling operations include receiving 402 an input, dividing 404 the input into a client portion and a server portion, translating 406 the client input portion into an executable client output, and translating 408 the server input portion into an executable server output. The operation of dividing the input into the client and server input portions may include applying a criteria to the input for selecting the two portions.

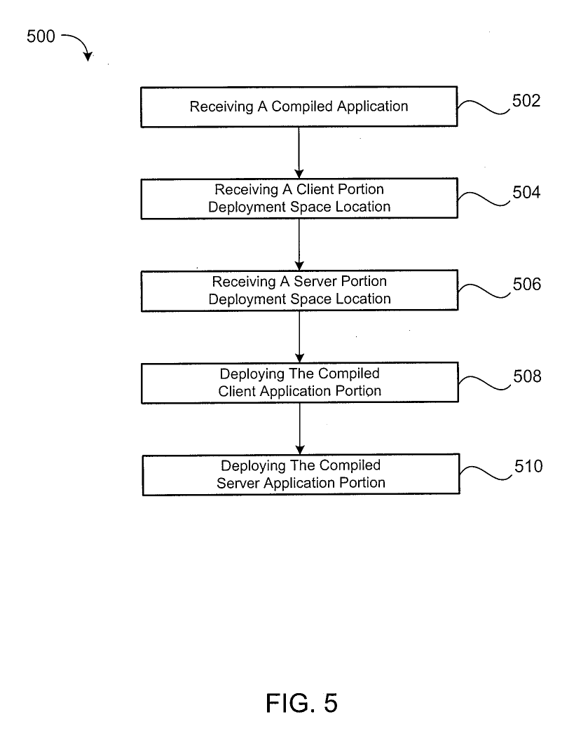

Referring to FIG. 5, a flowchart 500 represents an arrangement of deploying operations of the deployer 130. Typically, the deploying operations are executed on a processor present in the computer 100, upon which the deployer 130 resides; however, the operations may also be executed by multiple processors present in the computer 100. While typically executed by a single computer 100 (e.g., electronic device or computing device), in some arrangements, operation execution may be distributed among two or more computers 100. Deploying operations include receiving 502 a compiled application 160 (e.g., from a compiler 110 and/or IDE 140) having compiled client and server application portions 162, 164, receiving 504 a client portion deployment space location, receiving 506 a server portion deployment space location, and in response to receiving a deployment request (e.g., via the GUI 141 of the IDE 140), deploying 508 the compiled client application portion to a client deployment space according to the received client portion deployment space location, and also in response to receiving the deployment request, deploying 510 the compiled server application portion to a server deployment space according to the received server portion deployment space location. Exemplary client portion deployment space locations may include at least one of a local computing device 100 and a client computing device 200 having a plurality of computing devices and a service abstraction layer. Exemplary server portion deployment space locations may include at least one of a local computing device 200 and a cloud computing service 300 having a plurality of computing devices 302 and a service abstraction layer 304. Each deployment space may be associated with a name and a permissions requirement. Deploying operations may also include verifying user credentials before deploying the corresponding compiled application portion 162, 164, associating the corresponding compiled application portion 162, 164 with a computing device of the designated deployment space, and installing the corresponding compiled application portion 162, 164 to that computing device. Deploying operations may also include managing access to the corresponding compiled application portion 162, 164 according to a permissions requirement of the respective deployment space. Deploying operations can include assigning a permanent unique URL to each deployment space and mapping the permanent unique URL to a user-selected domain name.

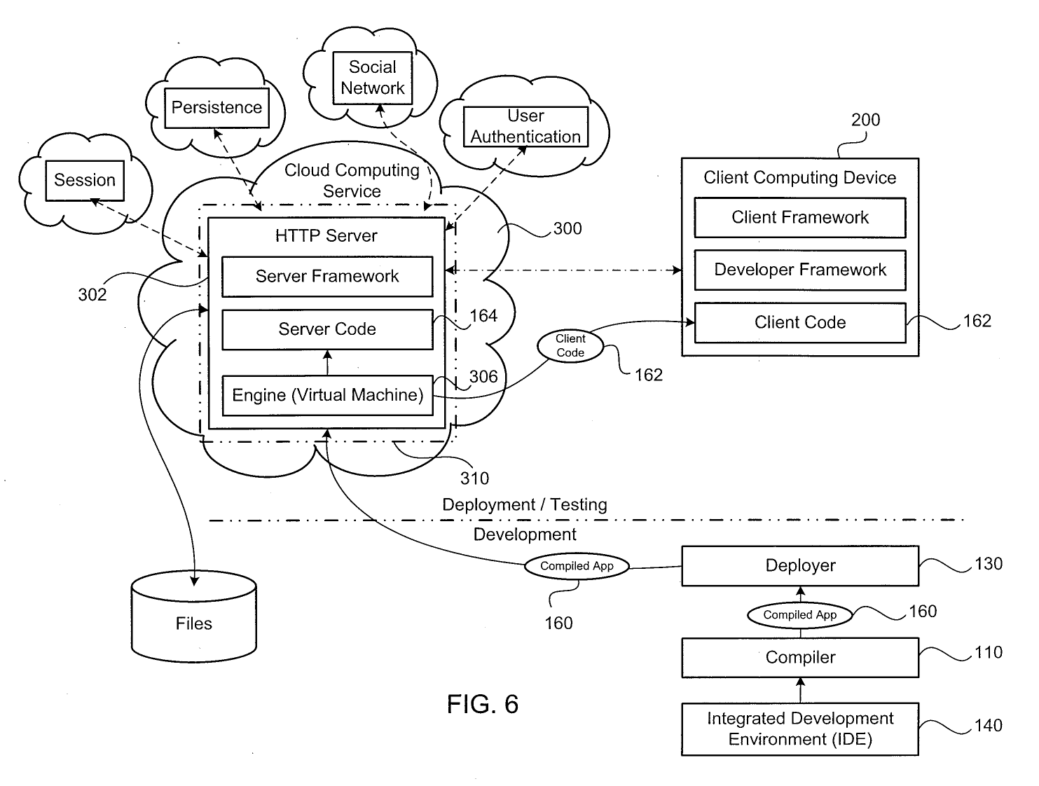

In the example illustrated in FIG. 6, the deployer 130 is configured to receive the compiled application 160 (e.g., from the compiler 110) for deployment to the server deployment space 310. A user preference may be set in the IDE 140 (e.g., via metadata, specific class usage in the source code, and/or properties) for producing the compiled client and server application portions 162, 164 at run-time from the compiled application 160. Deploying the compiled application 160 may include associating the compiled application 160 with the server deployment space 310, and installing the compiled application 160 to a server computing device 302 in the cloud computing service 300. In some examples, the server computing device 302 is selected from the plurality of server computing devices 302 in the cloud computing service 300 by evaluating a computing load for each server computing device 302. The cloud computing service 300 may assign a permanent unique URL to the server deployment space 310, which may be mapped to a user-selected domain name. Also, the cloud computing service 300 may process a permissions requirement of the server deployment space 310, and manage access to the compiled application 160 according to the permissions requirement of the server deployment space 310. In some examples, the cloud computing service 300 manages access to the compiled application 160 by requiring at least one of a user name and password to access the permanent unique URL. In the illustrated example, the virtual machine 306 on the server computing device 302 receives the compiled application 160 and is configured to produce the server and client application portions 162, 164, for example by applying a criteria. The criteria may include selecting portions of the compiled application 160 that have an execution time on the client computing device 200 less than a threshold client execution time and/or relate to a graphical user interface (GUI), and translating those portions into the compiled client application portion 162. In some examples, the criteria includes selecting portions of the compiled application 160 having an execution time on a client computing device 200 greater than a threshold client execution time, invoke services executable on a server computing device 302, and/or invoke application programming interfaces (API) executable on a server computing device 302, and translating those portions into the compiled server application portion 164. The server computing device 302 delivers the compiled client application portion 162 to a client deployment space 210 on a client computing device 200. The virtual machine 306 is configured to execute the compiled server application portion 164 and communicate with the client computing device 200 for execution of the compiled client application portion 162.

In the example illustrated in FIG. 7, the deployer 130 is configured to receive the compiled application 160 (e.g., from the compiler 110) for deployment to the client deployment space 210. A virtual machine 206 on the client computing device 200 receives the compiled application 160 and is configured to produce the server and client application portions 162, 164, for example by applying a criteria. The criteria may include any of the criteria described herein. The client computing device 200 delivers the compiled server application portion 164 to a server deployment space 310 on a server computing device 302. The virtual machine 206 is configured to execute the compiled client application portion 162 and communicate with the server computing device 302 for execution of the server client application portion 164. The virtual machine 306 on the server computing device 302 may execute the received server client application portion 164.

A communication module 350 (shown in FIG. 3) may be produced for communication between the compiled client and server application portions 162, 164. The communication module 350 may be produced by the compiler 110, the deployer 130, and/or a virtual machine 142, 144, 206, 306. In some examples, the compiler 110 produces the communication module 350 upon producing the compiled client and server application portions 162, 164. In other examples, the server virtual machine 306 produces the communication module 350 upon producing the compiled client and server application portions 162, 164 at run-time.

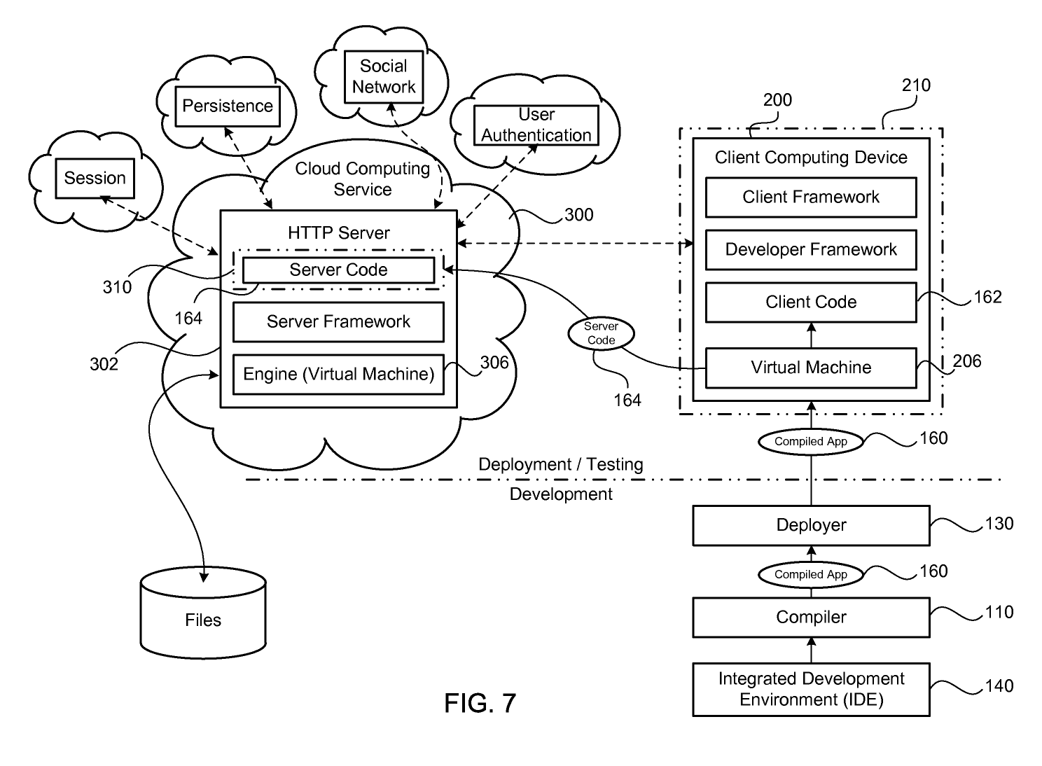

Referring to FIG. 8, in some implementations, the debugger 120 is configured to receive input from the IDE 140, such as the application 150 and/or the compiled application 160, for testing and debugging (e.g., identifying and correcting errors). The debugger 120 may be a computer program executable on the computer 100 or another computer. In some implementations, the debugger 120 uses artifacts (e.g., translated code, symbol table, and/or any special debugging output) in the compiled application 160 for debugging the application. In other implementations, the debugger 120 communicates with the compiler 110 to debug compilation and/or execution of the compiled application 160. In some examples, the source code of the application 150 to be monitored and/or examined by the debugger 120 may be executed on an instruction set simulator (ISS), which allows an execution sequence of the application 150 to be halted when specific conditions are encountered. In some implementations, the compiler 110 and the debugger 120 are part of the IDE 140 and communicate with each other for execution and testing of the application 150. While running the compiled application 160 produced by the compiler 110, the debugger 120 may show the position in the original source code of the application 150 when the compiled application 160 crashes or otherwise experiences an error and cannot continue to execute properly. In some examples, the debugger 120 is configured to offer the following operations while running the application 150: executing step by step (e.g., single-stepping), stopping execution (e.g., breaking or pausing the application to examine the current state) at some kind of event by way of a breakpoint, for example, and tracking values of variables in the application 150. In some examples, the debugger 120 is configured to modify the state of the compiled application 160 while running compiled application 160, rather than merely to observe it.

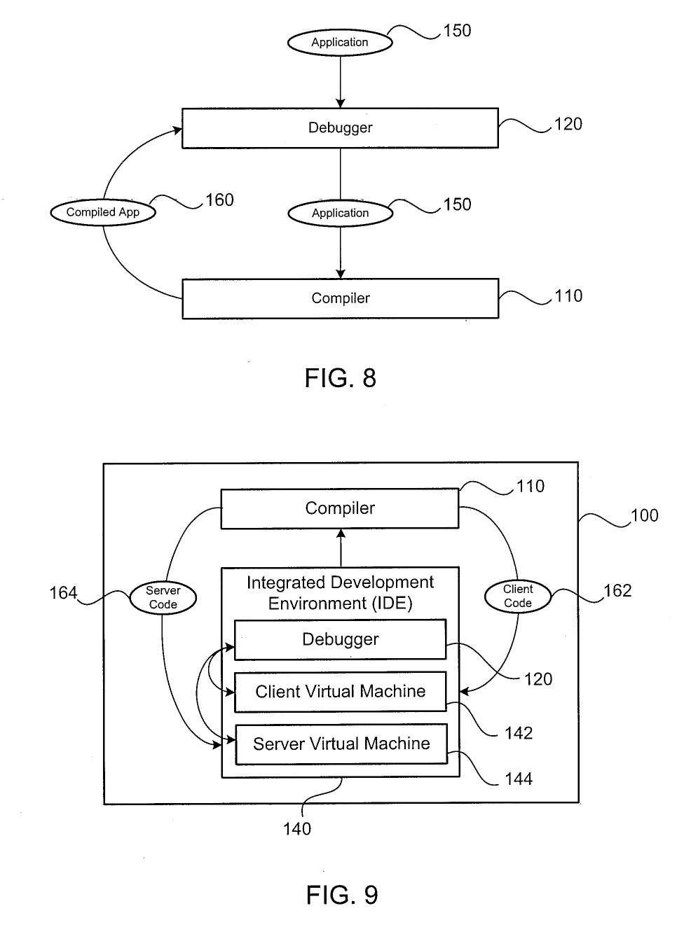

In some implementations, the debugger 120 is configured to receive a user testing preference for selecting a testing location of the compiled client and server application portions 162, 164. For example, the user may set the user testing preference for testing the compiled application 160 (both the compiled client and server application portions 162, 164) on a local computing device 100 executing the IDE 140. In the example shown in FIG. 9, the debugger 120 is part of the IDE 140 and communicates with the compiler 110 to receive the compiled client and server application portions 162, 164. The compiler 110 is shown separate from the IDE 140, but may be incorporated in the IDE 140. Similarly, the debugger 120 is shown part of the IDE 140, but may be separate from and communicates with the IDE 140. The compiler 110, debugger 1200, and IDE 140 are shown as executing on a computer 100; however, each of them may be executed on one or more separate computers or services communicating with one another. The debugger 120 is configured to run or execute the compiled client application portion 162 on a local client virtual machine 142 instantiated by the IDE 140 and run the compiled server application portion 164 on a local server virtual machine 144 instantiated by the IDE 140. The debugger 120 communicates with the local client and server virtual machines 142, 144 for monitoring execution of the compiled client and server application portions 162, 164. A virtual machine (VM) is a software implementation of a machine (e.g., a computer) that executes programs like a real machine. For example, a program written in Java receives services from a Java Runtime Environment (JRE) software program by issuing commands from which the expected result is returned by the Java software. By providing these services to the program, the JRE software is acting as a “virtual machine”, taking the place of the operating system or hardware for which the program would ordinarily have had to have been specifically written. The debugger 120 may communicate with the virtual machines 142, 144 over a network in an exemplary format of extensible markup language (XML), JSON, plain text, or a binary protocol. For example, the debugger 120 may communicate over TCP/IP sockets using hyper-text transfer protocol (HTTP). If both the client and server virtual machines are executing on the same computer, communication may occur through shared memory.

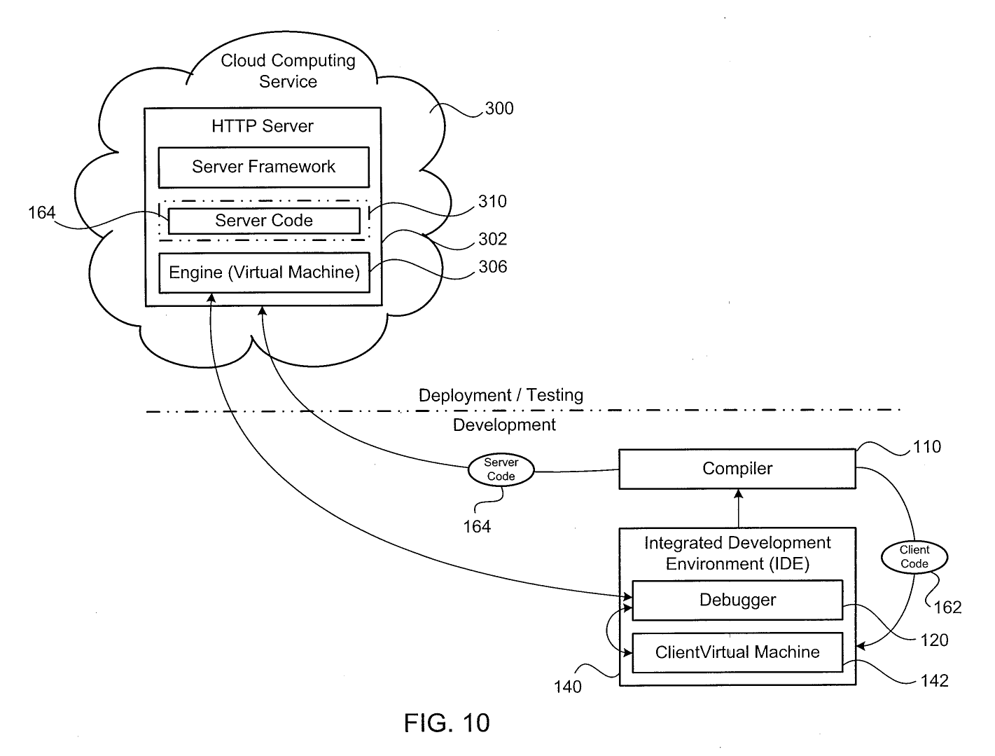

In some examples, the user sets the testing preference for testing the compiled client application portion 162 on a local computing device 100 (e.g., the computing device executing the IDE 140), and test the compiled server application portion 164 on the cloud computing service 300. In the example shown in FIG. 10, the debugger 120 is configured to run or execute the compiled client application portion 162 on the local client virtual machine 142 instantiated by the IDE 140 and run the compiled server application portion 164 on the server virtual machine 306 instantiated by the server computing device 302 in the cloud computing service 300. The debugger 120 communicates with the local client virtual machines 142 and the server virtual machine 306 for monitoring execution of the compiled client and server application portions 162, 164.

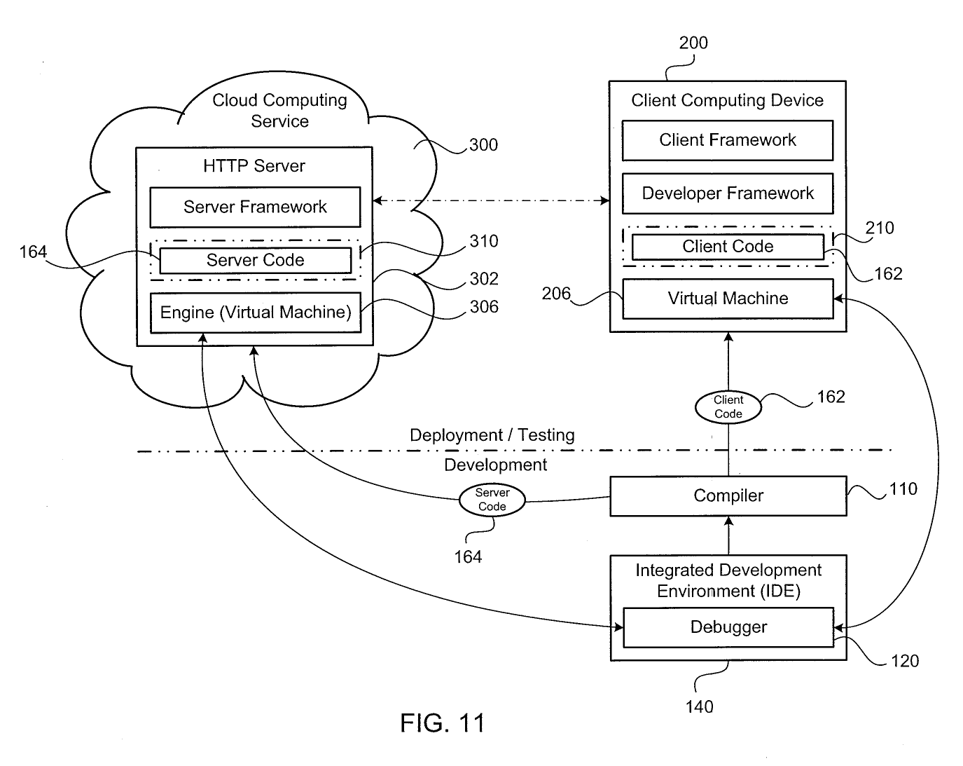

In some examples, the user sets the testing preference for testing the compiled client application portion 162 on the client computing device 200, and test the compiled server application portion 164 on the cloud computing service 300. In the example shown in FIG. 11, the debugger 120 is configured to run or execute the compiled client application portion 162 on a client virtual machine 206 instantiated by the client computing device 200 and run the compiled server application portion 164 on the server virtual machine 306 instantiated by the server computing device 302 in the cloud computing service 300. The debugger 120 communicates with the client virtual machine 206 and the server virtual machine 306 for monitoring execution of the compiled client and server application portions 162, 164.

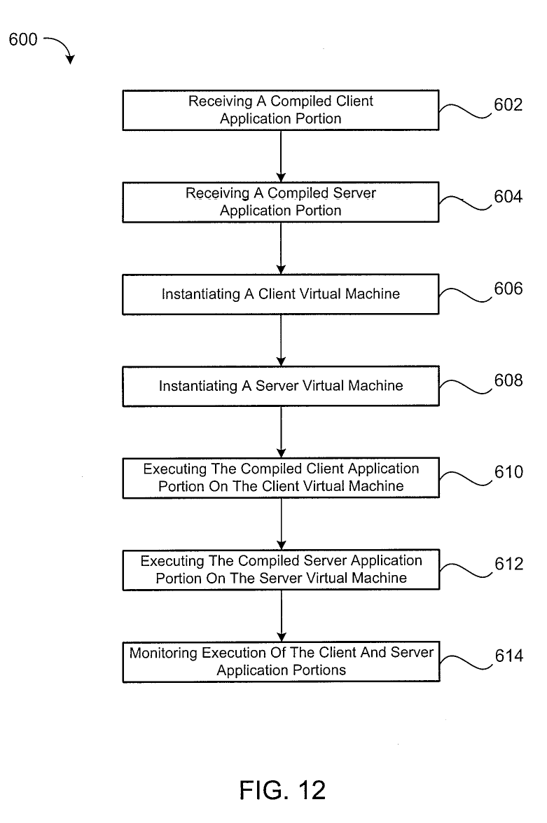

Referring to FIG. 12, a flowchart 600 represents an arrangement of debugging operations of the debugger 120. Typically, the debugging operations are executed on a processor present in the computer 100, upon which the debugging 120 resides; however, the operations may also be executed by multiple processors present in the computer 100. While typically executed by a single computer 100 (e.g., electronic device or computing device), in some arrangements, operation execution may be distributed among two or more computers 100. Debugging operations include receiving 602 a compiled client application portion 162, receiving 604 a compiled server application portion 164, instantiating 606 a client virtual machine 142, 206, and instantiating 608 a server virtual machine 144, 306. Debugging operations include executing 610 the compiled client application portion 162 on the client virtual machine 142, 206, executing 612 the compiled server application portion 164 on the server virtual machine 144, 306, and monitoring 614 execution of the compiled client and server application portions 162, 164, as by communicating with the local and server virtual machines 142, 206, 144, 306. In some implementations, debugging operations include receiving a testing location preference, such as testing the one or both of the compiled client and server application portions 162, 164 on one or more of a local machine 100, a cloud computing service 300, and a client computing device 200. The client virtual machine 142, 206 is instantiated on the local computing device 100 for testing the compiled client application portion 162 thereon. Similarly, the server virtual machine 144, 306 is instantiated on the local computing device 100 for testing the compiled server application portion 164 thereon. For testing on the cloud computing service 300, the server virtual machine 144, 306 is instantiated on a server computing device 302 in the cloud computing service 300 for executing the compiled server application portion 164. For testing on the client computing device 200, client virtual machine 142, 206 is instantiated on the client computing device 200 for executing the compiled client application portion 162. Monitoring execution of the compiled application 160 may include providing a source code location of the application 150 related to a failure of the compiled application 160, executing the compiled application 160 step-by-step of the application source code, stopping execution of the compiled application 160 for providing a variable state, and modifying a state of the executed compiled application 160.

Various implementations of the systems and techniques described here (e.g., the compiler 110, the debugger 120, and the deployer 130) can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

1. A computer implemented method comprising:
receiving, from a developer, programming language input that comprises development by the developer of a single application without the developer writing or managing (i) separate client and server code portions of the single application and (ii) communications therebetween;
translating the programming language input into a compiled application having a client portion and a server portion;
receiving a client portion testing location;
receiving a distinct server portion testing location;
instantiating a client virtual machine according to the client portion testing location;
instantiating a server virtual machine according to the server portion testing location;
executing the compiled client application portion on the instantiated client virtual machine;
executing the compiled server application portion on the instantiated server virtual machine; and
monitoring execution of the compiled client and server application portions on the respective client and server virtual machines, the monitoring execution comprising communicating with the client and server virtual machines for debugging the compiled application of the programming language input.

2. The computer implemented method of claim 1, wherein monitoring execution further comprises at least one of: providing a input source code location related to a failure of the compiled application, executing the compiled application step-by-step of the programming language input, stopping execution of the compiled application for providing a variable state, and modifying a state of the executed compiled application.

3. The computer implemented method of claim 1, wherein communicating with the client and server virtual machines comprises at least one of: communicating over a network and communicating within shared memory.

4. The computer implemented method of claim 1, wherein the client portion testing location comprises at least one of a local computing device and a client computing device.

5. The computer implemented method of claim 1, wherein the server portion testing location comprises at least one of a local computing device and a cloud computing service.

6. The computer implemented method of claim 1, further comprises applying a criteria to the input for translating the input into the compiled client and server application portions.

7. The computer implemented method of claim 6, wherein applying the criteria comprises translating portions of the input into the compiled client application portion that include at least one of: having an execution time on a client computing device less than a threshold client execution time, relating to a graphical user interface, metadata indicating inclusion in the compiled client application portion, source code class usage indicating inclusion in the compiled client application portion, and a combination thereof.

8. The computer implemented method of claim 6, wherein applying the criteria comprises translating portions of the input into the compiled server application portion that include at least one of: having an execution time on a client computing device greater than a threshold client execution time, invoking services running on a server computing device, invoking an application programming interface running on a server computing device, metadata indicating inclusion in the compiled server application portion, source code class usage indicating inclusion in the compiled server application portion, and a combination thereof.

9. The computer implemented method of claim 1, further comprising selecting a run-time environment and translating the input into the compiled client and server application portions based on the run-time environment.

10. The computer implemented method of claim 1, further comprising producing communication module for communication between the compiled client and server application portions.

11. A computer program product, encoded on a non-transitory computer-readable medium, operable to cause a data processing apparatus to perform operations comprising:
receiving, from a developer, programming language input that comprises development by the developer of a single application without the developer writing or managing (i) separate client and server code portions of the single application and (ii) communications therebetween;
translating the programming language input into a compiled application having a client portion and a server portion;
receiving a client portion testing location;
receiving a server portion testing location;
instantiating a client virtual machine according to the client portion testing location;
instantiating a server virtual machine according to the server portion testing location;
executing the compiled client application portion on the client virtual machine instantiated;
executing the compiled server application portion on the server virtual machine instantiated; and
monitoring execution of the compiled client and server application portions on the respective client and server virtual machines, the monitoring execution comprising communicating with the client and server virtual machines for debugging the compiled application of the programming language input.

12. The computer program product of claim 11, wherein monitoring execution further comprises at least one of: providing a input source code location related to a failure of the compiled application, executing the compiled application step-by-step of the programming language input, stopping execution of the compiled application for providing a variable state, and modifying a state of the executed compiled application.

13. The computer program product of claim 11, wherein communicating with the client and server virtual machines comprises at least one of: communicating over a network and communicating within shared memory.

14. The computer program product of claim 11, wherein the client portion testing location comprises at least one of a local computing device and a client computing device.

15. The computer program product of claim 11, wherein the server portion testing location comprises at least one of a local computing device and a cloud computing service.

16. The computer program product of claim 11, wherein the operations performed by the data processing apparatus further comprise applying a criteria to the input for translating the input into the compiled client and server application portions.

17. The computer program product of claim 16, wherein applying the criteria comprises translating portions of the input into the compiled client application portion that include at least one of: having an execution time on a client computing device less than a threshold client execution time, relating to a graphical user interface, metadata indicating inclusion in the compiled client application portion, source code class usage indicating inclusion in the compiled client application portion, and a combination thereof.

18. The computer program product of claim 16, wherein applying the criteria comprises translating portions of the input into the compiled server application portion that include at least one of: having an execution time on a client computing device greater than a threshold client execution time, invoking services running on a server computing device, invoking an application programming interface running on a server computing device, metadata indicating inclusion in the compiled server application portion, source code class usage indicating inclusion in the compiled server application portion, and a combination thereof.

19. The computer program product of claim 11, wherein the operations performed by the data processing apparatus further comprise selecting a run-time environment and translating the input into the compiled client and server application portions based on the run-time environment.

20. The computer program product of claim 11, wherein the operations performed by the data processing apparatus further comprise producing communication module for communication between the compiled client and server application portions.

21. A system comprising a computing device comprising:
a computer-readable medium including instructions;
one or more processors configured to execute the instructions and generate:
a compiler for receiving, from a developer, an input that comprises development by the developer of a single application without the developer writing or managing (i) separate client and server code portions of the single application and (ii) communications therebetween, translating the input into a compiled application having a client portion and a server portion; and
a debugger for executing the compiled client application portion on a client virtual machine instantiated according to a client portion testing location, executing the compiled server application portion on a server virtual machine instantiated according to a server portion testing location, and monitoring execution of the compiled client and server application portions on the respective client and server virtual machines, the monitoring execution comprising communicating with the client and server virtual machines for debugging the compiled application of the programming language input.

22. The system of claim 21, wherein monitoring execution further comprises at least one of: providing a input source code location related to a failure of the compiled application, executing the compiled application step-by-step of the programming language input, stopping execution of the compiled application for providing a variable state, and modifying a state of the executed compiled application.

23. The system of claim 21, wherein communicating with the client and server virtual machines comprises at least one of: communicating over a network and communicating within shared memory.

24. The system of claim 21, wherein the client portion testing location comprises at least one of a local computing device and a client computing device.

25. The system of claim 21, wherein the server portion testing location comprises at least one of a local computing device and a cloud computing service.

26. The system of claim 21, wherein the compiler is configured for applying a criteria to the input for translating the input into the compiled client and server application portions.

27. The system of claim 26, wherein applying the criteria comprises translating portions of the input into the compiled client application portion that include at least one of: having an execution time on a client computing device less than a threshold client execution time, relating to a graphical user interface, metadata indicating inclusion in the compiled client application portion, source code class usage indicating inclusion in the compiled client application portion, and a combination thereof.

28. The system of claim 26, wherein applying the criteria comprises translating portions of the input into the compiled server application portion that include at least one of: having an execution time on a client computing device greater than a threshold client execution time, invoking services running on a server computing device, invoking an application programming interface running on a server computing device, metadata indicating inclusion in the compiled server application portion, source code class usage indicating inclusion in the compiled server application portion, and a combination thereof.

29. The system of claim 21, wherein the compiler is configured for selecting a run-time environment and translating the input into the compiled client and server application portions based on the run-time environment.

30. The system of claim 21, wherein the compiler is configured for producing communication module for communication between the compiled client and server application portions.

31. The system of claim 21, further comprising:
a local computing device executing an integrated development environment comprising an editor, the compiler, and the debugger; and
a cloud computing service comprising a server computing device comprising a service abstraction layer and a hypertext transfer protocol wrapper over the server virtual machine instantiated thereon, the server computing device configured to parse HTTP requests and send HTTP responses.
